(19) United States
(12) Patent Application Publication
(10) Pub. No.: US 2008/0123243 A1
(43) Pub. Date: May 29, 2008

(54) FERROELECTRIC CAPACITOR

(75) Inventors: Yasuaki Hamada, Suwa (JP); Takeshi Kijima, Matsumoto (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 11/946,366

(22) Filed: Nov. 28, 2007

(30) Foreign Application Priority Data
Nov. 29, 2006 (JP) 2006-321868

(51) Int. Cl. H01G 4/00

(52) U.S. Cl. 361/301.1

(57) ABSTRACT

A ferroelectric capacitor includes: an electrode including a platinum film; a seed layer that is formed above the electrode and is composed of oxide having a perovskite structure expressed by a general formula, A(B₁₋ₓCₓ)O₃; and a ferroelectric layer formed above the seed layer, wherein A is composed of at least one of Sr and Ca, B is composed of at least one of Ti, Zr and Hf, C is composed of at least one of Nb and Ta, and X is in a range of 0<X<1.

The entire disclosure of Japanese Patent Application No. 2006-321868, filed Nov. 29, 2006 is expressly incorporated by reference herein.

### BACKGROUND

1. Technical Field

The invention relates to ferroelectric capacitors.

2. Related Art

Ferroelectric material is often used as an element placed between an upper electrode and a lower electrode in the capacitor structure. Such capacitors may be applied to ferroelectric memories and piezoelectric elements. The crystal orientation of each of the layers composing a ferroelectric capacitor is very important to drive the ferroelectric capacitor with low-voltage. For example, Japanese Laid-open Patent Application JP-A-2004-214274 describes a technology to align polarization axes by controlling crystal orientations of the ferroelectric layer.

### SUMMARY

In accordance with an aspect of an embodiment of the present invention, there is provided ferroelectric capacitors that are driven at a lower voltage.

A ferroelectric capacitor in accordance with an embodiment of the invention includes:

an electrode including a platinum film;

a seed layer that is formed above the electrode and is composed of oxide having a perovskite structure expressed by a general formula of A(B₁₋ₓ Cₓ)O₃; and

a ferroelectric layer formed above the seed layer, wherein A is composed of at least one of Sr and Ca, B is composed of at least one of Ti, Zr and Hf, C is composed of at least one of Nb and Ta, and X is in a range of 0<X<1.

It is noted that, in the invention, a specific B member (hereafter referred to as a “member B”) provided above a specific A member (hereafter referred to as a “member A”) includes a case where a member B is directly provided on a member A, and a case where a member B is provided over a member A through another member on the member A.

In the ferroelectric capacitor in accordance with the present embodiment of the invention, the seed layer is provided between the electrode and the ferroelectric layer, such that the crystallinity at an interface in the ferroelectric layer can be made better, which enables a low-voltage driving of the capacitor.

In the ferroelectric capacitor in accordance with an aspect of the embodiment of the invention, X may be in a range of 0.01≦X≦0.20.

In the ferroelectric capacitor in accordance with an aspect of the embodiment of the invention, the seed layer may have a film thickness of 1.5 nm or greater.

In the ferroelectric capacitor in accordance with an aspect of the embodiment of the invention, the seed layer may have a film thickness of 5.0 nm or smaller.

The ferroelectric capacitor in accordance with an aspect of the embodiment of the invention may further include a top layer that is formed above the ferroelectric layer and is composed of oxide having a perovskite structure expressed by a general formula of A(B_{1-Y} C_{Y})O₃, wherein A is composed of at least one of Sr and Ca, B is composed of at least one of Ti, Zr and Hf, C is composed of at least one of Nb and Ta, and Y is in a range of 0<Y<1.

In the ferroelectric capacitor in accordance with an aspect of the embodiment of the invention, Y may be 0.01 or greater.

In the ferroelectric capacitor in accordance with an aspect of the embodiment of the invention, the top layer may have a film thickness of 1.5 nm or greater.

In the ferroelectric capacitor in accordance with an aspect of the embodiment of the invention, the top layer may have a film thickness of 5.0 nm or smaller.

In the ferroelectric capacitor in accordance with an aspect of the embodiment of the invention, another electrode including a platinum film may be formed above the top layer.

In the ferroelectric capacitor in accordance with an aspect of the embodiment of the invention, the electrode may include an iridium film, an iridium oxide film formed on the iridium film, and a platinum film formed on the iridium oxide film, the seed layer may be formed on the platinum film, and the ferroelectric layer may be formed on the seed layer.

### BRIEF DESCRIPTION OF THE DRAWINGS

FIG. 1 schematically shows a cross-sectional view of a ferroelectric capacitor 100 in accordance with an embodiment of the invention.

FIG. 2 is a graph showing the applied-voltage dependency of the amount of remanent polarization (2Pr) of a ferroelectric capacitor in accordance with an embodiment of the invention.

FIG. 3 is a graph showing the fatigue characteristics of ferroelectric capacitors in accordance with an embodiment of the invention.

FIG. 4 shows XRD patterns of samples of experimental examples 1 and 2.

FIG. 5 is a cross-sectional view of a ferroelectric capacitor in accordance with an application example of the present embodiment.

FIG. 6 is a schematic cross-sectional view of a ferroelectric capacitor in accordance with a modified example.

### DESCRIPTION OF EXEMPLARY EMBODIMENTS

Preferred embodiments of the invention are described below with reference to the accompanying drawings.

### 1. FERROELECTRIC CAPACITOR

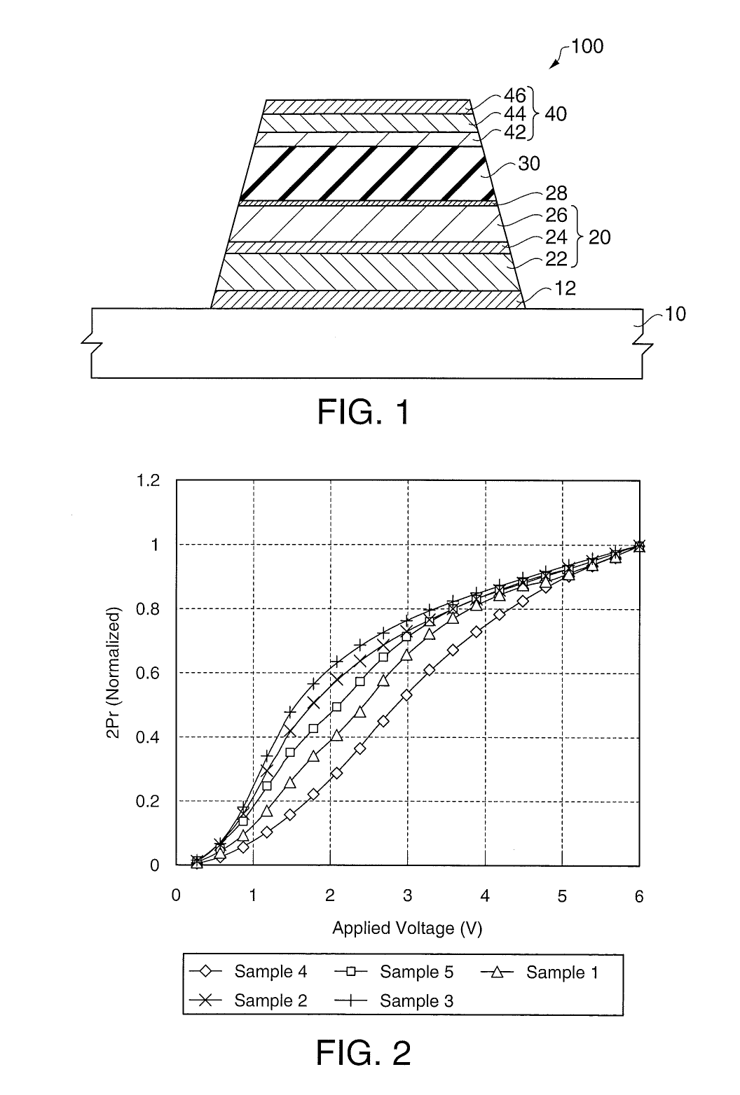

FIG. 1 is a cross-sectional view schematically showing a ferroelectric capacitor 100 in accordance with an embodiment of the invention. The ferroelectric capacitor 100 is formed on a base substrate 10, and includes a TiAlN film 12, a first electrode 20, a seed layer 28, a ferroelectric layer 30 and a second electrode 40, formed in this order from the side of the base substrate 10. The first electrode 20 includes a first iridium film 22, a first iridium oxide film 24 and a first platinum film 26, formed in this order from the side of the base substrate 10. The second electrode 40 includes a second platinum film 42, a second iridium oxide film 44 and a second iridium film 46, formed in this order from the side of the ferroelectric layer 30.

The base substrate 10 includes a substrate. The substrate may be formed from an element semiconductor such as silicon, germanium or the like, a semiconductor substrate composed of compound semiconductor such as GaAs, ZnSe or the like, a metal substrate composed of Pt or the like, a sapphire substrate, or a dielectric substrate composed of MgO, SrTiO₃, BaTiO₃, glass or the like. Also, the base substrate 10 may include a single transistor or a plurality of transistors on the substrate. The transistor may include impurity regions that define a source region or a drain region, a gate dielectric layer and a gate electrode. An element isolation region may be formed between the transistors, whereby electrical insulation between the transistors can be achieved.

The TiAlN film 12 is formed on the base substrate 10. The TiAlN film 12 is composed of nitride of titanium and aluminum (TiAlN), and has an oxygen barrier function. Also, the TiAlN film 12 has a face-centered cubic type crystal structure, and is preferentially oriented, for example, in a (111) plane or in a (200) plane. It is noted that the “preferentially oriented” state means a state in which the diffraction peak intensity from the (111) plane or the (200) plane is greater than diffraction peaks from other crystal planes in θ-2θ scanning of the X-ray diffraction method.

The first iridium film 22 is formed on the TiAlN film 12, and the first iridium oxide film 24 is formed on the first iridium film 22. The first iridium film 22 and the first iridium oxide film 24 may preferably be preferentially oriented in the (111) plane in at least a part thereof.

The first platinum film 26 is formed on the first iridium oxide film 24. The first platinum film 26 is preferentially oriented in a (111) plane. As a result, the seed layer 28 and the ferroelectric layer 30 to be formed thereon would likely be preferentially oriented in the (111) plane.

It is noted that the first electrode 20 may have all of the films described above, or may only have the first platinum film 26, or may be composed of the first platinum film 26, and the first iridium film 22 or the first iridium oxide film 24.

The seed layer 28 is formed on the first platinum film 26, and is composed of oxide having a perovskite structure expressed by the following general formula.

A(B₁₋ₓ Cₓ)O₃, where A is composed of at least one of Sr and Ca, B is composed of at least one of Ti, Zr and Hf, C is composed of at least one of Nb and Ta, and X is in a range of 0<X<1.

The seed layer 28, as a result of having the above-described structure, can have a lattice constant between the lattice constant of the ferroelectric layer 30 and the lattice constant of the first platinum film 26. By this, the seed layer 28 functions as a buffer that absorbs the difference in the lattice constant between the first platinum film 26 and the ferroelectric layer 30, and therefore can reduce lattice mismatch. Furthermore, the seed layer 28 described above is composed of oxide having conductivity, and thus can suppress the threshold voltage from becoming higher, compared to the case where a dielectric layer is provided below the ferroelectric layer 30, whereby a low-voltage drive becomes possible. Furthermore, even when A site or B site atoms composing the seed layer 28 diffuse in the ferroelectric layer 30, the ferroelectric layer 30 would not be changed to a conductive body, such that current leakage can be prevented.

The seed layer 28 may be composed of, for example, Sr(Ti₁₋ₓ Nbₓ)O₃ doped with niobium (hereafter referred to as Nb:STO). Sr contained in Nb:STO is difficult to be vacated, compared to other atoms used in a ferroelectric layer, such as, Pb. Therefore, by using Nb:STO as the seed layer 28, a highly reliable ferroelectric layer 30 can be obtained.

It is noted that, in Nb:STO, X may preferably be 0.01 or higher. The conductivity of the seed layer 28 is determined according to the rate of X. When X is less than 0.01, the conductivity becomes too low such that the threshold voltage becomes high. Also, X may preferably be 0.20 or less. When X is greater than 0.20, the crystallinity of the seed layer deteriorates, which negatively affects the crystallinity of the ferroelectric layer above the seed layer.

Also, the seed layer 28 may have a film thickness of 1.5 nm-5.0 nm. When the seed layer 28 has a film thickness of less than 1.5 nm, its function to absorb the lattice constant difference cannot be sufficiently exhibited. When the seed layer 28 has a film thickness greater than 5.0 nm, a low-voltage drive cannot be obtained.

The ferroelectric layer 30 is formed on the first electrode 20, in other words, on the first platinum film 26. The ferroelectric layer 30 may be composed of oxide having a perovskite type crystal structure. Above all, the oxide may preferably be ferroelectric compound that is expressed by a general formula of A(B_{1-Z} C_{Z})O₃, where the element A is at least Pb, the element B may be composed of at least one of Zr, Ti, V, W and Hf, and the element C may be composed of at least one of La, Sr, Ca and Nb. The ferroelectric layer 30 may be preferentially oriented in a (111) plane in order to draw out favorable polarization characteristics.

The second platinum film 42, the second iridium oxide film 44 and the second iridium film 46 composing the second electrode 40 are composed of the same materials as those of the first platinum film 26, the first iridium oxide film 24 and the first iridium film 22 described above, respectively, and therefore their description is omitted.

It is noted that the second electrode 40 may have all of the films described above, or may only have the second platinum film 42, or may be composed of the second platinum film 42, and the second iridium film 46 or the second iridium oxide film 44.

The ferroelectric capacitor in accordance with the present embodiment has the following structure. In accordance with the present embodiment, the first platinum film 26 and the seed layer 28 are formed below the ferroelectric layer 30. According to this structure, the first platinum film 26 composed of platinum having strong spontaneous orientation and high conductivity is formed as a base, whereby the seed layer 28 and the ferroelectric layer 30 formed thereon can have better crystallinity, which enables a low-voltage driving. Also, by forming the seed layer 28, lattice mismatch between the ferroelectric layer 30 and the first platinum film 26 can be reduced, whereby the crystallinity can be made even better.

### 2. METHOD FOR MANUFACTURING FERROELECTRIC CAPACITOR

First, a base substrate 10 is prepared. Then, a TiAlN film 12, a first iridium film 22, a first iridium oxide film 24 and a first platinum film 26 are sequentially formed above the base substrate 10.

The TiAlN film 12 may be formed by, for example, a sputter method or a CVD method. The film forming condition may be as follows. For example, when the film is formed by a sputter method, a mixed gas of argon and nitrogen gas may be used as the gas for processing. By adjusting the amount of nitrogen in the mixed gas, the TiAlN film 12 can be preferentially oriented in a (200) plane or in a (111) plane.

The first iridium film 22 and the first iridium oxide film 24 may be formed by any film forming method that is appropriately selected according to their material. For example, a sputter method, a vacuum vapor deposition method, a chemical vapor deposition (CVD) method may be used. The first platinum film 26 may be formed by a sputter method, or a vacuum vapor deposition method.

By the steps described above, a first electrode 20 composed of the first iridium film 22, the first iridium oxide film 24 and the first platinum film 26 is formed.

Next, a seed layer 28 is formed on the first electrode 20. The seed layer 28 may be formed by any film forming method that is appropriately selected according to its material. For example, a solution coating method (including a sol-gel method and an MOD (Metal Organic Decomposition) method), a sputter method, a CVD method, or a MOCVD (Metal Organic Chemical Vapor Deposition) method may be used. For example, for forming a film of Nb:STO by a sol-gel method, a precursor containing sol-gel raw materials of strontium, niobium and titanium is coated by spin-coat, then a heat treatment is conducted. As the raw material of strontium, carboxylate such as strontium acetate and strontium octylate may be enumerated. As the raw material of titanium, carboxylate such as titanium octylate, or alkoxide such as titanium isopropoxide may be enumerated. As the raw material of niobium, carboxylate such as niobium octylate, or alkoxide such as niobium ethoxide may be enumerated.

Then, a ferroelectric layer 30 is formed above the first electrode 20. The ferroelectric layer 30 may be formed by any film forming method that is appropriately selected according to its material. For example, a solution coating method (including a sol-gel method and an MOD method), a sputter method, a CVD method, or a MOCVD method may be used. After the film formation, a heat treatment may be applied according to the necessity. It is noted that the heat treatment may be conducted after forming a second electrode 40 to be described below.

Then, a second electrode 40 is formed on the ferroelectric layer 30. Concretely, a second platinum film 42, a second iridium oxide film 44 and a second iridium film 46 are sequentially formed. In the present embodiment, the second electrode 40 has the second platinum film 42, the second iridium oxide film 44 and the second iridium film 46, which are formed with the same materials as those of the first iridium film 22, the first iridium oxide film 24 and the first platinum film 26, respectively. As the film forming method, a film forming method similar to the method applied for forming the first electrode 20 may be used. The second electrode 40 may be formed from precious metal such as Pt, Ir or the like, or its oxide (for example, IrOₓ), without being limited to those described above. The second electrode 40 may be formed from a single layer of any of the above materials or a multilayer structure of laminated layers of plural materials. Then, patterning is conducted by known photolithography and etching technique.

Through the steps described above, the ferroelectric capacitor 100 in accordance with the present embodiment is manufactured.

### 3. EXPERIMENTAL EXAMPLES

Experimental examples in accordance with the present embodiment are described below.

### 3.1. Experimental Examples 1-3

Methods for manufacturing a ferroelectric capacitor in accordance with Experimental Examples 1-3 are as follows.

First, the surface of a silicon substrate was thermally oxidized, thereby forming a silicon oxide film having a film thickness of 400 nm. Then, a TiAlN film having a film thickness of 100 nm was formed on the silicon oxide film by a RF sputter method. Then, an iridium film having a film thickness of 100 nm and an iridium oxide film having a film thickness of 30 nm were formed on the TiAlN film by a DC sputter method. Then, a first platinum film having a film thickness of 100 nm was formed on the iridium oxide film by a vapor deposition method.

Then, a Nb:STO precursor was formed in a film on the first platinum film by a spin coat method, and the film was dried by a cleaning treatment at 300° C. for four minutes, thereby forming a seed layer having a film thickness of 3 nm.

Then, a precursor of PbZr_{0.15}Ti_{0.70}Nb_{0.15}O₃ (hereafter referred to as PZTN) was formed in a film on the seed layer by a spin coat method, and the film was crystallized by lamp heating at 650° C. for 5 minutes, thereby forming a PZTN film layer having a film thickness of 100 nm. Then, a second platinum film having a film thickness of 100 nm was formed on the PZTN film by a DC sputter method using a metal mask. Then, a recovery treatment was applied to the PZTN film by lamp heating at 650° C. for 5 minutes.

Ferroelectric capacitors were manufactured through the steps described above. A sample wherein X in Sr(Ti₁₋ₓ Nbₓ)O₃ was 0.01 was prepared as Sample 1 (Experimental Example 1), a sample wherein X was 0.05 was prepared as Sample 2 (Experimental Example 2), and a sample wherein X was 0.20 was prepared as Sample 3 (Experimental Example 3).

### 3.2. Experimental Example 4 (Comparison Example)

In Experimental Example 4, a seed layer was not formed, and a ferroelectric layer was provided directly on a first platinum film. A ferroelectric capacitor in accordance with Experimental Example 4 was manufactured by the following method.

First, the surface of a silicon substrate was thermally oxidized, thereby forming a silicon oxide film having a film thickness of 400 nm. Then, a TiAlN film having a film thickness of 100 nm was formed on the silicon oxide film by a RF sputter method. Then, an iridium film having a film thickness of 100 nm and an iridium oxide film having a film thickness of 30 nm were formed on the TiAlN film by a DC sputter method. Then, a first platinum film having a film thickness of 100 nm was formed on the iridium oxide film by a vapor deposition method.

Then, a PZTN precursor was formed in a film on the first platinum film by a spin coat method, and the film was crystallized by lamp heating at 650° C. for 5 minutes, thereby forming a PZTN film layer having a film thickness of 100 nm. Then, a second platinum film having a film thickness of 100 nm was formed on the PZTN film by a DC sputter method using a metal mask. Then, a recovery treatment was applied to the PZTN film by lamp heating at 650° C. for 5 minutes.

Sample 4 was manufactured through the steps described above.

### 3.3. Experimental Example 5 (Comparison Example)

In Experimental Example 5, SrTiO₃ that is not doped with niobium was used as a seed layer. A ferroelectric capacitor in accordance with Experimental Example 5 was manufactured by the following method.

First, the surface of a silicon substrate was thermally oxidized, thereby forming a silicon oxide film having a film thickness of 400 nm. Then, a TiAlN film having a film thickness of 100 nm was formed on the silicon oxide film by a RF sputter method. Then, an iridium film having a film thickness of 100 nm and an iridium oxide film having a film thickness of 30 nm were formed on the TiAlN film by a DC sputter method. Then, a first platinum film having a film thickness of 100 nm was formed on the iridium oxide film by a vapor deposition method.

Then, a SrTiO₃ precursor was formed in a film on the first platinum film by a spin coat method, and the film was dried by a cleaning treatment at 300° C. for four minutes, thereby forming a seed layer having a film thickness of 3 nm.

Then, a PZTN precursor was formed in a film on the seed layer by a spin coat method, and the film was crystallized by lamp heating at 650° C. for 5 minutes, thereby forming a PZTN film layer having a film thickness of 100 nm. Then, a second platinum film having a film thickness of 100 nm was formed on the PZTN film by a DC sputter method using a metal mask. Then, a recovery treatment was applied to the PZTN film by lamp heating at 650° C. for 5 minutes.

Sample 5 was manufactured through the steps described above.

### 3.4. Evaluation 1

Samples 1-5 were evaluated. The evaluation on Samples 1-5 was conducted for their remanent polarization values and fatigue characteristics. FIG. 2 is a graph showing application voltage dependency of remanent polarization amount (2Pr). In FIG. 2, applied voltage values are plotted along an axis of abscissa, and remanent polarization amounts are plotted along an axis of ordinates. In FIG. 2, Samples 1-3 each provided with a seed layer have a greater amount of remanent polarization, and were saturated at a lower voltage, compared to Sample 4 in which no seed layer is provided. Accordingly, it was confirmed that the ferroelectric capacitors in accordance with the present embodiment could exhibit favorable characteristics at a lower voltage.

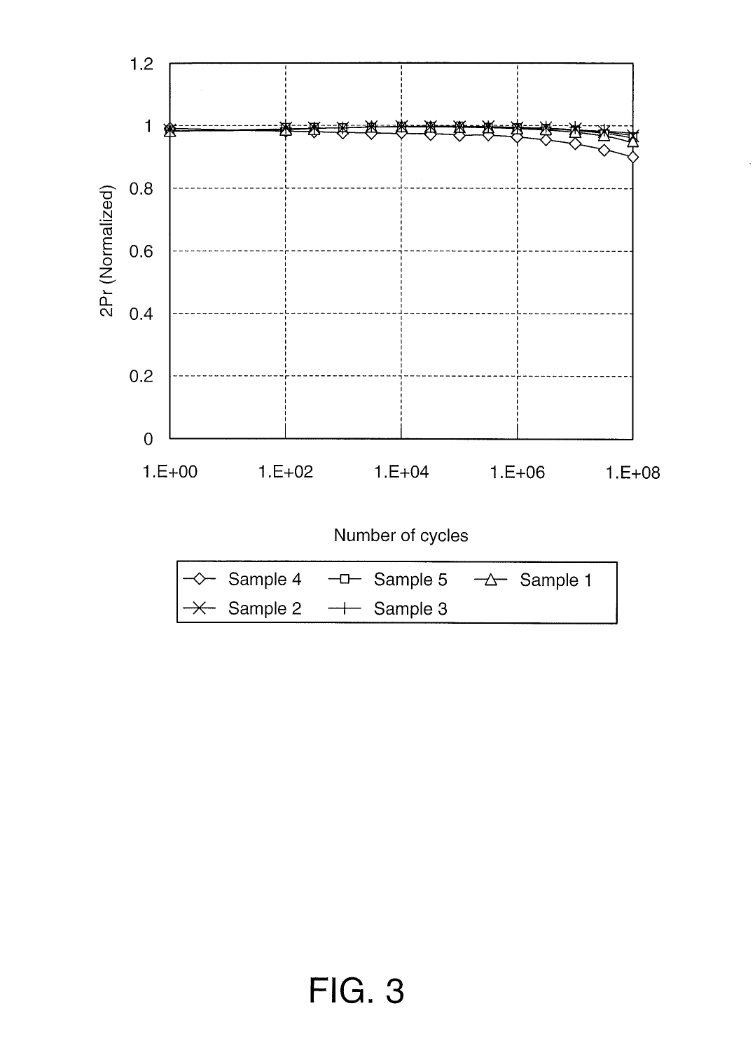

FIG. 3 is a graph showing the fatigue characteristic of ferroelectric capacitors. In FIG. 3, the number of cycles is plotted along an axis of abscissa, and the remanent polarization amount (2Pr) is plotted along an axis of ordinates. In here, fatigue characteristics by bipolar square waves at 1.8V with 100 kHz are shown. It was confirmed from FIG. 3 that, after 10⁶ cycles in particular, a reduction in remanent polarization amount of Samples 1-3 each provided with a seed layer was suppressed, compared to Sample 4 in which no seed layer was provided, and their fatigue characteristics could be improved.

### 3.5. Experimental Example 6

Sample 6 in accordance with Experimental Example 6 was manufactured by the following method.

The surface of a silicon substrate was thermally oxidized, thereby forming a silicon oxide film having a film thickness of 400 nm. A titanium film was formed on the silicon oxide film by a DC sputter method, and a titanium oxide film layer having a film thickness of 40 nm was formed by thermal oxidation. Then, a first platinum film having a film thickness of 200 nm was formed on the titanium oxide film by an ion sputter method and a vapor deposition method. A precursor of Sr(Ti_{1-0.01} Nb_{0.01})O₃ was coated in a film on the first platinum film by a spin coat method, and the film was dried by a cleaning treatment at 300° C. for 4 minutes, thereby forming a seed layer composed of Sr(Ti_{1-0.01} Nb_{0.01})O₃ having a film thickness of 3 nm. Then, a PZTN precursor was formed in a film by a spin coat method, and then crystallized by lamp heating at 650° C. for 5 minutes, thereby forming a PZTN film layer having a film thickness of 100 nm.

### 3.6. Experimental Example 7

In Experimental Example 7, a seed layer was not formed, and a ferroelectric layer was provided directly on a first platinum film. Sample 7 in accordance with Experimental Example 7 was manufactured by the following method.

First, the surface of a silicon substrate was thermally oxidized, thereby forming a silicon oxide film having a film thickness of 400 nm. Then, a titanium film was formed on the silicon oxide film by a DC sputter method, and then a titanium oxide film layer having a film thickness of 40 nm was formed by thermal oxidation. Then, a first platinum film having a film thickness of 200 nm was formed on the titanium oxide film by an ion sputter method and a vapor deposition method. Then, a PZTN precursor was formed in a film by a spin coat method, and then crystallized by lamp heating at 650° C. for 5 minutes, thereby forming a PZTN film layer having a film thickness of 100 nm.

### 3.7. Evaluation 2

X-ray diffraction analysis was conducted on Sample 6 wherein the seed layer was provided below the ferroelectric layer, and on Sample 7 wherein no seed layer was provided.

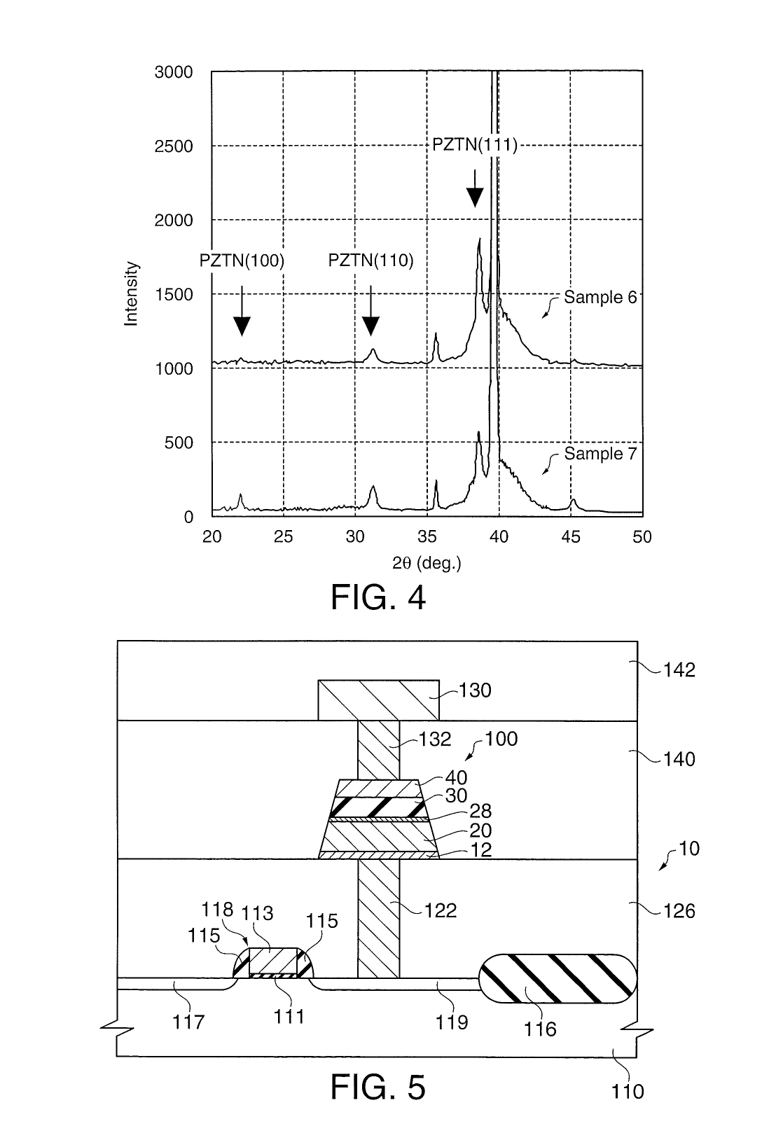

FIG. 4 shows XRD patterns of Sample 6 and Sample 7. It is assumed that a peak near 2θ=38.5° is derived from PZTN having a (111) orientation. According to FIG. 4, the peak intensity of Sample 6 that is provided with the seed layer is more than 1.5 times the peak intensity of Sample 7 that is not provided with a seed layer. Accordingly, it was confirmed that the crystallinity was improved by providing the seed layer.

### 4. APPLICATION EXAMPLE

Next, an example of a ferroelectric memory including a ferroelectric capacitor in accordance with the present embodiment is described. FIG. 5 is a cross-sectional view for describing the ferroelectric memory in accordance with the application example.

As shown in FIG. 5, a MOS transistor 118 is formed on a silicon substrate 110 that is a semiconductor layer. An example of the process is described below. First, an element isolation film 116 for defining an active region is formed in the silicon substrate 110. Then, a gate oxide film 111 is formed in the defined active region. A gate electrode 113 is formed on the gate oxide film 111, sidewalls 115 are formed on side walls of the gate electrode 113, and impurity regions 117 and 119 that form a source and a drain are formed in the silicon substrate 110 that is located at a device region. In this manner, the MOS transistor 118 is formed in the silicon substrate 110.

Next, a first interlayer dielectric film 126 composed of silicon oxide as a principle constituent is formed over the MOS transistor 118, and a contact hole that connects to the impurity region 117 or 119 is further formed in the first interlayer dielectric film 126. An adhesion layer (not shown) and a W plug 122 are embedded in the contact hole. Then, a ferroelectric capacitor 100 that is connected to the W plug 122 is formed on the first interlayer dielectric film 126.

The ferroelectric capacitor 100 has a structure in which a lower electrode 20, a ferroelectric layer 30 and an upper electrode 40 are laminated in this order. The ferroelectric capacitor 100 may be formed by the film forming method described above. Then, a second interlayer dielectric film 140 composed of silicon oxide as a principle constituent is formed on the ferroelectric capacitor 100, and a via hole located above the ferroelectric capacitor 100 is formed. An adhesion layer and a W plug 132 connected to the ferroelectric capacitor 100 are embedded in the via hole. Al alloy wiring 130 connected to the W plug 132 is formed on the second interlayer dielectric film 140. Then, a passivation film 142 is formed on the second interlayer dielectric film 140 and the Al alloy wiring 130.

### 5. MODIFIED EXAMPLE

A modified example in accordance with the present embodiment is described below. A ferroelectric capacitor 200 in accordance with the modified example further includes a top layer, which is different from the ferroelectric capacitor 100 of the present embodiment.

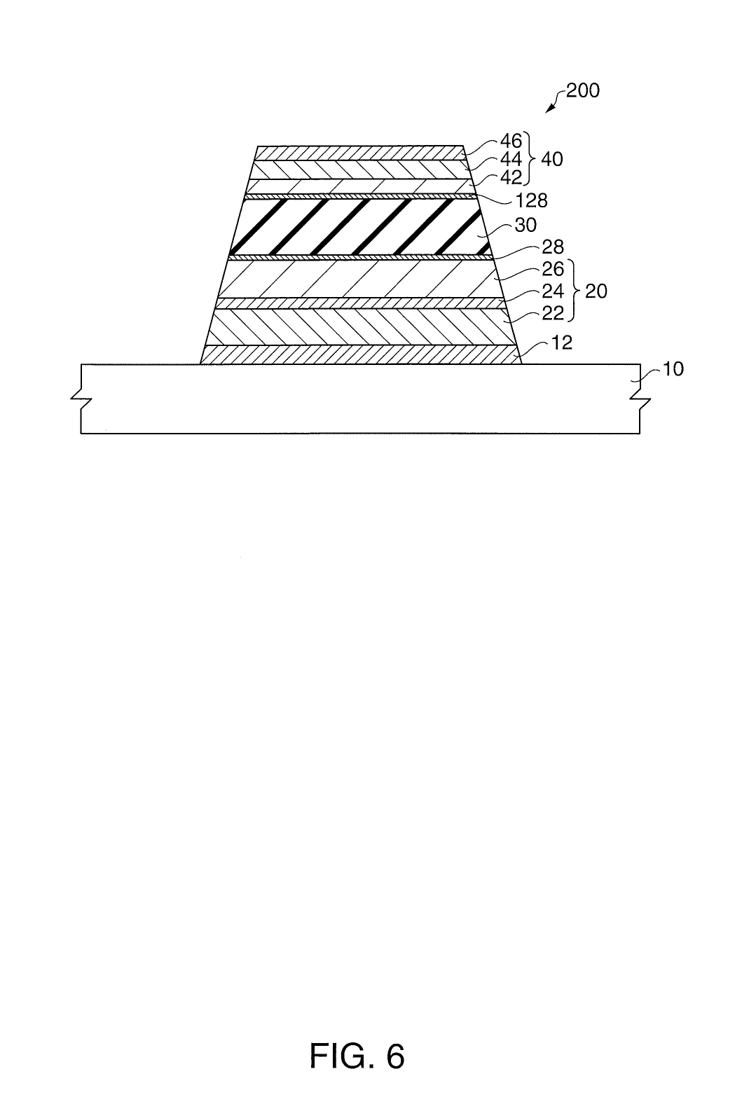

FIG. 6 is a schematic cross-sectional view of the ferroelectric capacitor 200 in accordance with the modified example. The ferroelectric capacitor 200 includes a TiAlN film 12, a first electrode 20, a seed layer 28, a ferroelectric layer 30, a top layer 128 and a second electrode 40, formed in this order from the side of the base substrate 10. The top layer 128 is formed on the ferroelectric layer 30, and is composed of oxide having a perovskite structure expressed by the following general formula, like the seed layer 28.

A(B_{1-Y} C_{Y})O₃, where A is composed of at least one of Sr and Ca, B is composed of at least one of Ti, Zr and Hf, C is composed of at least one of Nb and Ta, and Y is in a range of 0<Y<1.

The top layer 128, as a result of having the above-described structure, can have a lattice constant between the lattice constant of the ferroelectric layer 30 and the lattice constant of the second platinum film 42. By this, the top layer 128 functions as a buffer that absorbs the difference in the lattice constant between the second platinum film 42 and the ferroelectric layer 30, therefore can reduce lattice mismatch, and makes better the crystallinity at an interface between the second platinum film 42 and the ferroelectric layer 30. Furthermore, the top layer 128 described above is composed of oxide having conductivity, and thus can suppress the threshold voltage from becoming higher, compared to the case where a dielectric layer is provided above the ferroelectric layer 30, whereby a low-voltage drive becomes possible. Furthermore, even when A site or B site atoms composing the top layer 128 diffuse in the ferroelectric layer 30, the ferroelectric layer 30 would not be changed to a conductive body, such that current leakage can be prevented.

The top layer 128 may be composed of, for example, Sr(Ti_{1-Y} Nb_{Y})O₃ doped with niobium (hereafter referred to as Nb:STO). Sr contained in Nb:STO is difficult to be vacated, compared to other atoms used in a ferroelectric layer, such as, Pb. Therefore, by using Nb:STO as the top layer 128, a highly reliable ferroelectric layer 30 can be obtained.

It is noted that, in Nb:STO, Y may preferably be 0.01 or higher. The conductivity of the top layer 128 is determined according to the rate of Y. When Y is less than 0.01, the conductivity becomes too low such that the threshold voltage becomes high.

Also, the top layer 128 may have a film thickness of 1.5 nm-5.0 nm. When the top layer 128 has a film thickness of less than 1.5 nm, its function to absorb the lattice constant difference cannot be sufficiently exhibited. When the top layer 128 has a film thickness greater than 5.0 nm, its conductivity becomes lower than that of the second platinum film 42, and a low-voltage drive cannot be realized.

Next, a method for manufacturing the ferroelectric capacitor 200 in accordance with the modified example is described. The process of forming the ferroelectric layer 30 is conducted in the same manner as described above.

Next, a top layer 128 is formed on the ferroelectric layer 30. The top layer 128 may be formed by any film forming method that is appropriately selected according to its material. For example, a solution coating method (including a sol-gel method and an MOD (Metal Organic Decomposition) method), a sputter method, a CVD method, or a MOCVD (Metal Organic Chemical Vapor Deposition) method may be used. For example, for forming a film of Nb:STO by a sol-gel method, a precursor containing sol-gel raw materials of strontium, niobium and titanium is coated by spin-coat, then a heat treatment is conducted. As the raw material of strontium, carboxylate, such as, strontium acetate and strontium octylate may be enumerated. As the raw material of titanium, carboxylate such as titanium octylate, or alkoxide such as titanium isopropoxide may be enumerated. As the raw material of niobium, carboxylate such as niobium octylate, or alkoxide such as niobium ethoxide may be enumerated.

Then, a second platinum film 42 is formed on the top layer 128. The steps after the step of forming the second platinum film 42 are generally the same as those of the method for manufacturing the ferroelectric capacitor 100 described above, and therefore their description is omitted.

Other compositions of the ferroelectric capacitor 200 in accordance with the modified example are the same as those of the other compositions of the ferroelectric capacitor 100 described above and its manufacturing method, and therefore their description is omitted.

The invention may include compositions that are substantially the same as the compositions described in the embodiments (for example, a composition with the same function, method and result, or a composition with the same objects and result). Also, the invention includes compositions in which portions not essential in the compositions described in the embodiments are replaced with others. Also, the invention includes compositions that achieve the same functions and effects or achieve the same objects of those of the compositions described in the embodiments. Furthermore, the invention includes compositions that include publicly known technology added to the compositions described in the embodiments.

What is claimed is:

1. A ferroelectric capacitor comprising:
an electrode including a platinum film;
a seed layer that is formed above the electrode and is composed of oxide having a perovskite structure expressed by a general formula, A(B₁₋ₓ Cₓ)O₃; and
a ferroelectric layer formed above the seed layer,
wherein A is composed of at least one of Sr and Ca, B is composed of at least one of Ti, Zr and Hf, C is composed of at least one of Nb and Ta, and X is in a range of 0<X<1.

2. A ferroelectric capacitor according to claim 1, wherein X is in a range of 0.01≦X≦0.20.

3. A ferroelectric capacitor according to claim 1, wherein the seed layer has a film thickness of 1.5 nm or greater.

4. A ferroelectric capacitor according to claim 1, wherein the seed layer has a film thickness of 5.0 nm or smaller.

5. A ferroelectric capacitor according to claim 1, further comprising a top layer that is formed above the ferroelectric layer and is composed of oxide having perovskite structure expressed by a general formula A(B_{1-Y} C_{Y})O₃, wherein A is composed of at least one of Sr and Ca, B is composed of at least one of Ti, Zr and Hf, C is composed of at least one of Nb and Ta, and Y is in a range of 0<Y<1.

6. A ferroelectric capacitor according to claim 5, wherein Y is 0.01 or greater.

7. A ferroelectric capacitor according to claim 5, wherein the top layer has a film thickness of 1.5 nm or greater.

8. A ferroelectric capacitor according to claim 5, wherein the top layer has a film thickness of 5.0 nm or smaller.

9. A ferroelectric capacitor according to claim 5, wherein another electrode including a platinum film is formed above the top layer.

10. A ferroelectric capacitor according to claim 1, wherein the electrode includes an iridium film, an iridium oxide film formed on the iridium film, and a platinum film formed on the iridium oxide film, the seed layer is formed on the platinum film, and the ferroelectric layer is formed on the seed layer.
